(19) United States
(12) Patent Application Publication
(10) Pub. No.: US 2026/0118734 A1
(43) Pub. Date: Apr. 30, 2026

(54) Optical Parametric Amplifier

(71) Applicant: SI Stuttgart Instruments GmbH, Stuttgart (DE)

(72) Inventors: Tobias Steinle, Stuttgart (DE); Harald Giessen, Marnheim (DE)

(21) Appl. No.: 18/937,298

(22) Filed: Nov. 5, 2024

(30) Foreign Application Priority Data
Nov. 6, 2023 (DE) 10 2023 130 602.2

(51) Int. Cl. G02F 1/39

(52) U.S. Cl. CPC G02F 1/392

(57) ABSTRACT

An optical parametric amplifier including an amplifier crystal and a mirror arrangement having a plurality of mirrors. The mirror arrangement has an in-coupling mirror and an out-coupling mirror. Pump light is coupled into the mirror arrangement via the in-coupling mirror. Signal light and idler light are generated in the amplifier crystal by means of the pump light. The signal light leaves the mirror arrangement via the out-coupling mirror. The pump light is directed several times through the amplifier crystal in the mirror arrangement. Pomp light and signal light are guided collinearly in the mirror arrangement.

### CROSS-REFERENCE TO RELATED APPLICATION

This application claims priority to German Patent Application No. 10 2023 130 602.2 filed Nov. 6, 2023, the disclosure of which is hereby incorporated by reference in its entirety.

### BACKGROUND OF THE INVENTION

### Field of the Invention

The present invention relates to an optical parametric amplifier, in particular for generating and amplifying laser radiation in variable wavelength ranges.

### Description of Related Art

There are various approaches to generating tunable laser radiation, such as optical parametric sources, quantum cascade lasers (QCL), diode lasers having an external cavity (ECDL) or solid-state lasers (e.g. based on titanium:sapphire or Cr:ZnSe). All approaches have a limited tuning range, wherein the nature of this limitation can be divided into two groups.

The first group (“laser-based”) is intrinsically linked to the ability of the laser-active medium to amplify light through stimulated emission. The examples mentioned are the broadest bandwidth representatives of their type and achieve maximum tunability of approx. +/−20% in relation to the central wavelength. No laser medium has yet been found that can amplify an octave (e.g. 500-1000 nm, or 750-1500 nm).

The second group are optical parametric sources. Since there is no energy exchange with the amplification medium and no electronic, vibratory or rotational transitions are excited, there is no fundamental limitation in the tuning range. Optical parametric amplifiers can therefore theoretically convert any frequencies into each other, but are dependent on the fulfillment of the so-called phase matching on the one hand, and limited to the transparency range of the amplifier medium on the other hand.

This basically makes a wavelength range covering one or more octaves (e.g. 1.5-4.5 μm) accessible.

Even with a given material transparency, there are two limitations due to the need for phase matching:

On the one hand, several elements must always be moved (almost always mechanically) in tunable sources in order to cover a large spectral range. This places high technical demands on the optical design, the automation of the control and the user of the system and is accompanied by signs of wear. At the same time, a very expensive technology is required for the production of the amplifier crystal, which is only mastered by a few suppliers worldwide, significantly influences the system costs and thus stands in the way of economic scaling.

On the other hand, phase matching also fundamentally limits the product of gain and spectral bandwidth. In practice, short pulses (<50 fs) can therefore often only be amplified with difficulty or under certain conditions (e.g. certain pump signal wavelength pairs in certain crystals). This limitation is of a fundamental nature and can be broken down to the following principle:

Short crystals enable broadband amplification, but with decreasing efficiency. Long crystals enable good efficiency, but only in a narrow-band wavelength range.

The limited bandwidth and efficiency can be broken down into two main factors:
(1) Optical parametric amplification is reversible (so that the pump light is not converted into signal light and idler light, but signal light and idler light are consumed and pump light is generated). Only the relative optical phase of the three waves involved determines the direction of the energy flow. This usually changes as it passes through the crystal. It can be matched to an exact triplet of wavelengths (“phase matching”). Dephasing of the process occurs with increasing spectral distance from this operating point. Reconversion occurs from a certain propagation/crystal length. The longer the propagation distance through the crystal, the smaller the permitted spectral distance to the ideal operating point before this effect occurs.
(2) Temporal “walk-off” between the laser pulses that are to be converted, so that energy conversion is no longer possible due to temporal separation. This effect is caused by a different group velocity or dispersion of the individual laser pulses due to the different wavelengths of pump light and signal light (and also idler light).

It is an object of the present invention to provide an optical parametric amplifier with an improved conversion efficiency of the pump light into signal light, an improved gain and an improved gain bandwidth.

### SUMMARY OF THE INVENTION

The object of the invention is achieved by an optical parametric amplifier as described herein.

The optical parametric amplifier according to the present invention comprises an amplifier crystal and a mirror arrangement having a plurality of mirrors. Furthermore, the mirror arrangement has an in-coupling mirror and an out-coupling mirror, with the in-coupling mirror coupling pump light into the mirror arrangement. The pump light is used to generate signal light and idler light in the amplifier crystal, with the signal light and any remaining pump light leaving the mirror arrangement via the out-coupling mirror. In particular, unamplified signal light can be coupled into the mirror arrangement as a seed together with the pump light, wherein the coupled, unamplified signal light is then amplified in the amplifier crystal. Here, in-coupling mirrors and out-coupling mirrors can be provided as separate optical elements. Alternatively, in-coupling mirrors and/or out-coupling mirrors are mirrors of the mirror arrangement that redirect pump light and signal light within the mirror arrangement. In particular, the in-coupling mirror and the out-coupling mirror can be the same mirror.

Here and throughout the following description, the optical parametric amplifier according to the invention is described by means of an amplification of the signal light. In particular, signal light can refer to the short-wavelength/energetically higher light that is produced during the conversion process in which pump light is converted into signal light and idler light. Alternatively, signal light and idler light can be interchanged, so that signal light refers to the long-wavelength/energetically lower light that is produced from the pump light during the conversion process.

Due to the mirror arrangement, according to the invention, the pump light is directed several times through the amplifier crystal in several cycles in the mirror arrangement, so that a multi-pass geometry is created by the mirror arrangement. In this respect, a cycle is defined as the path of the pump light through the entire mirror arrangement until the pump light returns to the output mirror. Thus, the pumping light, starting from the output mirror, can be returned to the output mirror by at least one or more reflections on each mirror of the mirror arrangement (possibly also on the output mirror itself, if the pumping light is reflected more than once on the output mirror in one cycle), which corresponds exactly to one cycle.

According to the invention, the pump light and signal light are guided collinearly in the mirror arrangement. Thus, the pump light and signal light follow an identical path through the mirror arrangement. As the pump light circulates several times within the mirror arrangement, the signal light, which is generated in the amplifier crystal, is also guided in several cycles in the mirror arrangement. The multi-pass geometry results in repeated generation of the signal light, which amplifies the signal light that reaches the out-coupling mirror. In particular, an almost linear amplification of the signal light with the number of cycles of the pump light and the signal light in the mirror arrangement can be achieved. This enables high amplification and power scaling with a gain factor of up to 1000 or more can be achieved compared to conventional optical parametric amplifiers, in particular with single passage through the amplifier crystal. Furthermore, it is not necessary to use a particularly long amplifier crystal for such amplification, which would also limit the possible gain bandwidth, as explained above. Thus, a short amplifier crystal can be used, enabling high conversion efficiency and a wide gain bandwidth. Furthermore, crystals that are easy to manufacture can be used and still achieve large tuning ranges. “Easy” here refers to the fact that, for example, the time-consuming step of periodic polishing is not absolutely necessary.

Preferably, the optical parametric amplifier is configured to be passed through bidirectionally, so that light can pass through the amplifier and in particular the mirror arrangement on an identical but opposite path.

Preferably, the pump light only passes through the mirror arrangement once. The optical parametric amplifier is thus configured as an OPA (optical parametric amplifier), wherein, as explained above, the pump light naturally passes through several cycles within the mirror arrangement in the multi-pass geometry of the mirror arrangement.

Alternatively, the mirror arrangement is arranged in a resonator so that pump light and/or signal light oscillate in the resonator. The optical parametric amplifier is thus configured as an OPO (optical parametric oscillator).

Preferably, the resonator is a fiber feedback resonator (FFR). The optical parametric amplifier is thus configured as a fiber feedback resonator OPO (optical parametric oscillator) (FFOPO). Thus, in addition to the non-linear amplifier crystal, an optical fiber, in particular configured as a single-mode fiber, is arranged inside the resonator, through which the light is guided in each cycle. The resonator can be a ring resonator or a linear resonator. The concept has the following advantages: The fiber makes it possible to realize any path length in the smallest of spaces. Thus, a compact structure can be achieved. Furthermore, such a fiber has a spatially stabilizing effect, as the light always passes from the same point (fiber exit) into the free beam part of the resonator. This greatly suppresses misalignment effects, e.g. due to mirror tilting. The fiber also has the spatially stabilizing effect that higher modes cannot circulate in the resonator, since the fiber is configured as a single-mode fiber and can only carry the fundamental mode, thus suppressing higher modes in each cycle. Furthermore, the fiber has a time-stabilizing effect, as it intentionally introduces a lot of dispersion into the resonator. Individual spectral components therefore return to the amplifier crystal at different times after a cycle and only a small proportion of these have a temporal overlap with the pump pulse. As a result, precisely these spectral components are amplified in a very stable manner. Therefore, spectral drifts are typically 20-200 times weaker than in conventional resonators.

The first disadvantage of the fiber-feedback concept is that the fiber introduces significantly increased losses into the resonator, since the radiation must be coupled into a fiber at least once, and in linear resonators even at least twice. These losses typically amount to 50-80% of the cycle loss. The second disadvantage is that the fiber can only be exposed to a limited power (typically a few mW to a few tens of mW), which limits the maximum output power of the FFOPO. This has two consequences: In order to function efficiently with these losses, an FFOPO needs a high degree of outcoupling. This prevents a lot of power being lost in the high-loss resonator. However, this further increases the resonator cycle loss, so that typically 98-99.9% cycle loss is achieved. This means that the concept only works if the losses can be compensated for by the gain in the amplifier medium. FFOPOs therefore require a very high small-signal gain, typically a gain of 50×-1000×, in order to function efficiently. Achieving this amplification in conventional OPAs/OPOs is not easy, as conventional crystals usually do not allow such enormous small-signal gains. With the multi-pass arrangement according to the present invention it could be shown that the small-signal gain could be improved by orders of magnitude. Therefore, there are two advantages of combining FFOPO and the arrangement according to the present invention: The arrangement according to the present invention compensates precisely for the weakness of the FFOPO of the principle-related high losses due to its intrinsically high small-signal gain. The FFOPO uses spatially stabilizing effects to ensure that the beam can be guided precisely over many mirrors and prevents higher spatial modes from forming.

This combination expands the scope of application of FFOPOs with regard to two factors: FFOPOs with very short pulses (20-100 fs) become possible. In the conventional way, no known material is capable of generating sufficient small-signal gain for this application case. FFOPOs with higher output power become possible. In the conventional way, the maximum feedback power limits the maximum achievable output power.

Preferably, the amplifier crystal is arranged in a focal point of the mirror arrangement. Here, the focal point is a common point that the pump light and signal light pass through in each of the cycles. This is a simple way of ensuring that the amplifier crystal also passes through the mirror arrangement in each of the cycles of the pump light, so that signal light and idler light are generated. In particular, the amplifier crystal is arranged at the focal point of the mirror arrangement.

Preferably, the mirror arrangement has one and in particular exactly one intersection point. At the intersection point of the mirror arrangement, the beam path of the pump light and the beam path of the signal light intersect within one cycle, respectively. This is a geometric location that is particularly independent of a focal point of the pump light or signal light, i.e. the location of maximum focusing. For example, known geometries such as the “Herriot cell” do not have such an intersection point, but show a circular beam pattern, which is intended to avoid excessive radiation densities within the amplifier medium. However, this is not necessary in the present invention, as the intersection point and focal point can be selected independently of each other. By providing an intersection point, a simple and particularly compact design can be selected.

Preferably, the focal point of the mirror arrangement and the intersection point match or coincide.

Preferably, the pump light or signal light does not pass through the amplifier crystal in parallel due to the intersection point.

Preferably, the mirror arrangement does not have any transmissive optics, such as lenses or the like. Otherwise, in particular when generating short pulses, dispersion would be generated unintentionally and chromatic aberrations would be added.

Preferably, the pump light hits one or more of the mirrors of the mirror arrangement several times. In particular, the pump light hits each of the mirrors of the mirror arrangement several times, so that the pump light is directed through the amplifier crystal several times. This means that the number of mirrors required and thus the optical components of the optical parametric amplifier can be kept small. This can reduce the costs of assembly and complexity. As described above, one or more of these mirrors can also serve as a in-coupling mirror and/or out-coupling mirror.

Preferably, the pump light passes through the amplifier crystal exactly once, in particular exactly twice and preferably more than twice, during one cycle through the mirror arrangement.

Preferably, the pump light passes through the amplifier crystal more than 4 times in total when passing through the mirror arrangement, and in particular more than 10 times in total. In other words, the mirror arrangement is configured to guide pump light in more than 2 cycles, in particular more than 4 cycles, preferably more than 5 cycles and particularly preferably more than 10 cycles within the mirror arrangement (depending on whether the amplifier crystal is passed through once or twice per cycle).

Preferably, the signal light and the pump light pass through the mirror arrangement in a planar geometry. In other words, the signal light and the pump light are located in a common plane when circulating through the mirror arrangement. This is a simple way of ensuring that the polarization is maintained during cycle. Alternatively, the signal light and pump light can pass through the mirror arrangement in a 3D geometry, which means that more cycles can be achieved with the same mirror size. Here, however, polarization may be lost. With a 3D geometry, it is not possible to find a uniform plane in which all the beams of pump light and signal light are located within the mirror arrangement.

Preferably, one or more mirrors of the mirror arrangement is/are at least partially transparent to the idler light. Reconversion from idler light and signal light to pump light can only take place if idler light and signal light come together in the amplifier crystal. Since one or more mirrors of the mirror arrangement are at least partially transparent for the idler light, the idler light is not reflected on the mirror but is coupled out of the mirror arrangement and is therefore not available for reconversion. This means that one or more mirrors are absorptive or transmissive for the wavelength of the idler light. In particular, the one or more mirrors have a reflectivity of 50% or less, preferably 10% or less and particularly preferably 2% or less for the idler light, such that 50% or less, preferably 10% or less and particularly preferably 2% or less of the idler light is reflected by the one or more mirrors.

In particular, all mirrors of the mirror arrangement have a reflectivity of 95% or more, preferably 99% or more and particularly preferably 99.9% or more for the pump light and/or the signal light, so that 95% or more, preferably 99% or more and particularly preferably 99.9% or more of the pump light and/or the signal light is reflected by the mirrors of the mirror arrangement.

Preferably, the amplifier crystal has a length that is equal to or less than the (temporal) walk-off length between signal light and pump light. The walk-off length refers to the length that the signal light and pump light overlap in time due to the different group velocity within the mirror arrangement and the amplifier crystal. This ensures that pump light is efficiently converted into signal light within the amplifier crystal and, in particular, that no reconversion takes place when the walk-off length is exceeded. The use of a short crystal therefore improves the conversion efficiency.

Preferably, the pump light is reflected on one or more of the mirrors at different locations on the respective mirror surface of the mirror. Pump light (and, due to the collinear guidance, also signal light and idler light) therefore hit the mirror surface at different locations and are reflected. This means that a multi-pass geometry can be achieved with relatively few optical elements, as the mirror surface of a mirror is used several times to reflect the signal light, pump light and/or idler light. In particular, when the signal light and the pump light pass through the mirror array in a planar geometry, the locations on the mirror surface are arranged along a straight line, this line representing the intersection line between the common plane of the planar geometry and the mirror surface.

Preferably, at least one mirror of the mirror arrangement is configured as a focusing mirror for generating a focal point in which the amplifier crystal is arranged. In this case, the focusing mirror can be a curved mirror, wherein the mirror surface is particularly formed to be convex and particular preferred as a spherical mirror or parabolic mirror. In particular, the focal point is created by the curvature of the focusing mirror. Furthermore, due to the different locations at which the pump light and signal light hit the mirror surface of the focusing mirror, the intersection point can be created. The focusing mirror thus generates the focal point and also defines the beam path in the multi-pass geometry. This means that both the focal point and the intersection point of the beam path within the mirror arrangement can be selected independently and optimally by appropriately selecting the focusing mirror and the locations at which the pump light or signal light is reflected on the focusing mirror.

Preferably, one or more mirrors and in particular all mirrors of the mirror arrangement are configured as dichroic mirrors.

Preferably, the dispersion of the mirrors of the mirror arrangement is configured to substantially compensate for the dispersion of signal light and pump light per cycle. The mirrors of the mirror arrangement thus compensate for a group velocity delay and in particular a group velocity dispersion. This ensures that no dephasing of pump light and signal light occurs within the mirror arrangement, which would reduce the conversion efficiency. A compensation of the dispersion takes place in particular over a bandwidth of 10 nm or more, preferably 100 nm or more and particularly preferably 1000 nm or more. For example, compensation in the range of wavelengths between 1500 nm and 1900 nm is possible. Thus, the mirrors of the mirror arrangement provide both dispersion correction and spectral filtering if one or more mirrors of the mirror arrangement are at least partially transparent to the idler light.

Preferably, the photon conversion efficiency is more than 60%, preferably more than 70% and particularly preferably more than 80%. This means that more than 60% of the pump light is converted into signal light and idler light. In this respect, the photon conversion efficiency refers to the efficiency with which pump photons are converted into signal photons and idler photons.

Preferably, the pump light is pulsed with a pulse length of less than 250 fs and in particular less than 150 fs. In particular, the signal light is pulsed with a pulse length of less than 10 ps and in particular less than 500 fs. Here, in particular, the pulse duration of the signal pulses is substantially stable and independent of the amplification. In particular, it is possible to directly amplify pulses with pulse lengths of down to 25 fs, preferably down to 10 fs.

Preferably, the amplifier crystal has a length of 10 mm or less, preferably 5 mm or less and particularly preferably 1 mm or less. In particular with pulse lengths of 500 fs and less and in particular 25 fs and less, short amplifier crystals are required to obtain a sufficient bandwidth.

Alternatively, the amplifier crystal has a length of 25 mm and more. In particular when amplifying long pulses with pulse lengths of more than 1 ps, in particular more than 1 ns or cw amplification, long amplifier crystals can be used to improve efficiency.

Preferably, a seed is used to initiate the conversion process. Here, the amplifier crystal is illuminated with laser light so that one mode of the amplifier crystal is preferred, which is then used for the conversion process. Here, the wavelength of the seed substantially corresponds to the wavelength of the signal light or the idler light. In particular, it is a cw seed. Alternatively, the seed can also be pulsed and preferably have a pulse length that substantially corresponds to the pulse length of the pump light.

Preferably, the mirror arrangement has less than 10 mirrors, preferably 6 or less mirrors and particularly preferably 4 or less mirrors. In particular, the mirror arrangement has exactly 4 mirrors. Alternatively, the mirror arrangement has exactly 6 mirrors.

Preferably, the mirror arrangement has a crystal mirror, with the crystal mirror being arranged in particular at the intersection point of the mirror arrangement. Thus, almost all the light rays of a cycle hit a point on a small surface on the crystal mirror. The crystal mirror can therefore be small.

Preferably, the amplifier crystal is arranged between the focusing mirror and the crystal mirror.

Preferably, the crystal mirror is configured as a planar mirror.

Preferably, the crystal mirror is integrated into the amplifier crystal. In particular, the focal point and intersection point coincide with the crystal mirror and the amplifier crystal and are therefore all in the same place. In this respect, the crystal mirror can be configured as a dichroic coating of one side of the amplifier crystal.

Preferably, the mirror arrangement has at least one and preferably exactly one or exactly 2 retroreflectors. In this respect, a retroreflector can be formed by two planar mirrors positioned at an angle to each other. In particular, the angle is 90°. In particular, none of the retroreflectors are formed by a prism. Particularly with short pulses, the use of a prism would create unwanted dispersion. Alternatively, the amplifier crystal is prism-shaped, so that a retroreflector is formed by the angled side faces of the amplifier crystal. For this purpose, the side surfaces of the amplifier crystal can have a dichroic coating, in particular.

Preferably, the amplifier crystal is arranged at least partially between the mirrors of the at least one retroreflector.

Preferably, the location of the intersection point is between the mirrors of the at least one retroreflector or, starting from the focusing mirror, behind the mirrors of the at least one retroreflector.

Preferably, the crystal mirror is located between the mirrors of the at least one retroreflector or, starting from the focusing mirror, behind the mirrors of the at least one retroreflector.

Preferably, the amplifier crystal is passed through between the focusing mirror and the crystal mirror. In this respect, the crystal mirror can be formed integrally/in one piece/monolithically with the amplifier crystal or directly connected thereto. Alternatively, the crystal mirror is configured as a separate component and is spaced apart from the amplifier crystal. In particular, the amplifier crystal is passed through exactly twice per cycle, once from the focusing mirror to the crystal mirror and once from the crystal mirror to the focusing mirror.

Preferably, the mirror arrangement comprises a first mirror, a focusing mirror, a second mirror and a crystal mirror, wherein a cycle comprises: a first reflection on the first mirror to the focusing mirror, a second reflection on the focusing mirror to the crystal mirror, a third reflection on the crystal mirror to the focusing mirror, a fourth reflection on the focusing mirror to the second mirror and a fifth reflection on the second mirror to the first mirror, wherein pump light and signal light pass through several cycles. The first mirror, the focusing mirror, the second mirror and the crystal mirror thus create a multi-pass geometry in which the pump light and signal light circulate several times and pass through the amplifier crystal several times.

Preferably, the amplifier crystal is passed through between the second mirror and the first mirror, the amplifier crystal being passed through in particular at different locations. Thus, the amplifier crystal is passed through when transitioning from the first cycle to the second cycle and to every subsequent cycle.

Preferably, different signal and idler wavelength pairs are amplified at different pass-through positions of the amplifier crystal. This can be achieved, for example, by a different length or changing the periodic polarity of the crystal.

Preferably, the mirror arrangement comprises a first mirror, a first focusing mirror, a second mirror, a third mirror, a second focusing mirror and a fourth mirror, the first focusing mirror and the second focusing mirror having a common focal point at which the amplifier crystal is arranged.

Preferably, a cycle comprises: a first reflection on the first mirror to the first focusing mirror, a second reflection on the first focusing mirror to the second focusing mirror, a third reflection on the second focusing mirror to the second mirror, a fourth reflection on the second mirror to the third mirror, a fifth reflection on the third mirror to the second focusing mirror, a sixth reflection on the second focusing mirror to the first focusing mirror, a seventh reflection on the first focusing mirror to the fourth mirror and an eighth reflection on the fourth mirror to the first mirror, wherein the pump light and signal light pass through several cycles.

Preferably, the pump light hits one of the respective mirrors exactly once per cycle and one of the respective focusing mirrors exactly twice.

Preferably, the amplifier crystal is lithium tantalate, lithium niobate, PPLN (periodically poled LiNbO₃), KTP (KTIOPO₄), or BBO (Ba(BO₂)₂).

Preferably, it is not a periodically poled crystal. This significantly simplifies the manufacturing process for the amplifier crystal, thus reducing costs and increasing availability.

Preferably, at least one mirror and the amplifier crystal are monolithically formed. Here, one side surface of the amplifier crystal can have a suitable coating in order to generate reflectivity at least for the pump light and the signal light. Alternatively, two mirrors and the amplifier crystal are monolithically formed. In particular, this can be the first mirror and the second mirror of the arrangement described above and/or the third mirror and the fourth mirror.

Preferably, all mirrors of the mirror arrangement and the amplifier crystal are monolithically formed. Mirrors of the mirror arrangement are formed in particular on the side surfaces of the amplifier crystal. This results in long crystal lengths that are passed through, which can be particularly advantageous for long pulse lengths of more than 1 ps, more than 1 ns and in particular cw operation.

Thus, an optical parametric amplifier having a very high conversion efficiency due to the use of short crystals to suppress reconversion is provided. This also results in a large gain bandwidth due to the use of short amplifier crystals. In addition, there is a very high small-signal gain due to the multiple amplification. At the same time, the optical parametric amplifier has good power scalability due to its multi-pass geometry. Here, the multi-pass geometry is achieved by a mirror arrangement having only a small number of mirrors. For example, in particular four mirrors are already sufficient to provide a suitable mirror arrangement.

### BRIEF DESCRIPTION OF THE DRAWINGS

The terms Fig., Figs., Figure, and Figures are used interchangeably in the specification to refer to the corresponding figures in the drawings.

In the following, the invention is described in more detail by means of preferred embodiments with reference to the accompanying figures.

FIG. 1A is an embodiment of the optical parametric amplifier according to the invention,

FIG. 1B is a further embodiment of the optical parametric amplifier according to the invention,

FIG. 1C is a further embodiment of the optical parametric amplifier according to the invention,

FIG. 1D is a further embodiment of the optical parametric amplifier according to the invention,

FIG. 2 is a dispersion diagram of the mirror arrangement,

FIG. 3 is a further embodiment of the optical parametric amplifier according to the present invention, and

FIG. 4 is a characterization of the optical parametric amplifier according to FIG. 1.

### DESCRIPTION OF THE INVENTION

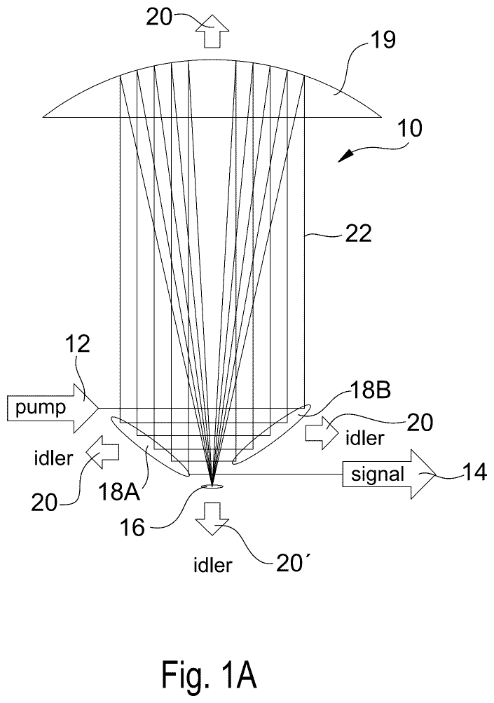

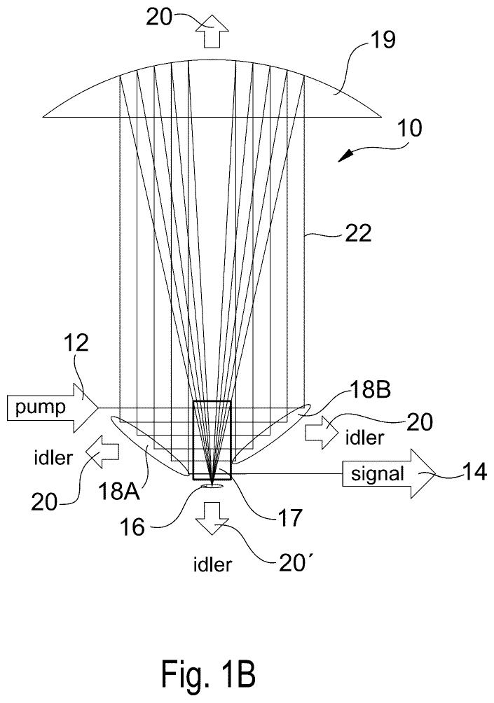

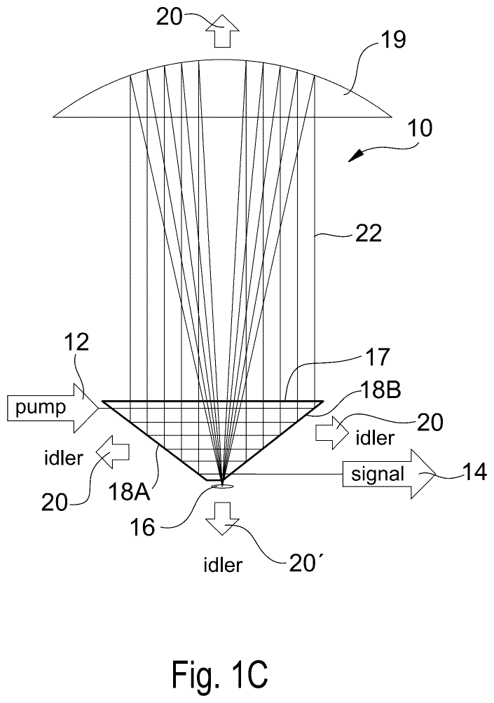

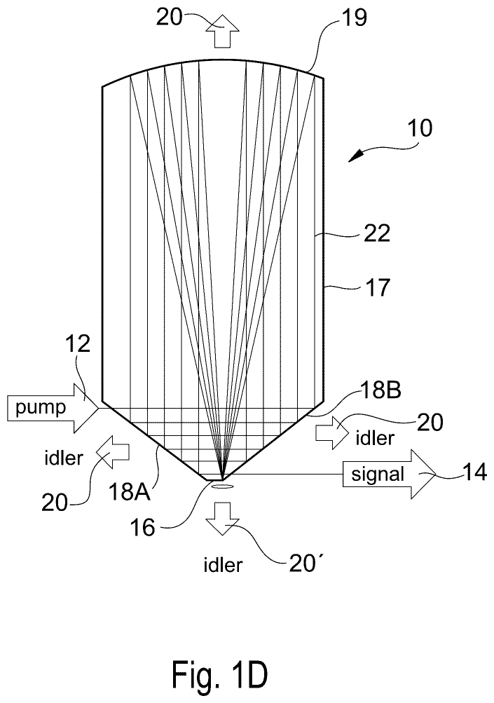

FIG. 1A shows an optical parametric amplifier according to the present invention. The optical parametric amplifier comprises a mirror arrangement 10 having a first mirror 18A, a second mirror 18B, a focusing mirror 19 and a crystal mirror which is combined with an amplifier crystal. In this respect, the crystal mirror 16 can be applied directly to one side of the amplifier crystal or can be directly adjacent to the amplifier crystal, for example. In particular, the crystal mirror 16 and the amplifier crystal are monolithically formed. At least the first mirror 18A, the second mirror 18B and the focusing mirror 19 are configured as dichroic mirrors. In particular, all mirrors are configured as dichroic mirrors. The amplifier crystal is arranged in the focal point of the focusing mirror 19. Pump light 12 enters the mirror arrangement 10 via a in-coupling mirror. Unamplified signal light can also be coupled into the mirror arrangement 10 via the in-coupling mirror and then amplified in the amplifier crystal. In the example of FIG. 1A, the second mirror 18B also serves as an in-coupling mirror. The pump light 12 is reflected from the second mirror 18B to the focusing mirror 19 and then guided to the amplifier crystal. Subsequently, signal light 14 and idler light is generated from the pump light 12 in the amplifier crystal. The pump light 12, signal light 14 and idler light are guided collinearly within the mirror arrangement 10, wherein they are thus shown uniformly as one light beam 22 in the figures. Signal light 14 and pump light 12 are then reflected on the crystal mirror 16 through the amplifier crystal to the focusing mirror 19 and therefrom to the first mirror 18A. Pump light 12 and signal light 14 are then reflected from the first mirror 18A to the second mirror 18B, wherein a further cycle begins. The pump light 12 and at least also the signal light 14 are directed through the amplifier crystal along several cycles within the mirror arrangement 10. Here, the pump light 12 is converted into signal light 14 and idler light each time. The mirrors 18A, 18B, 19 and/or the crystal mirror 16 of the mirror arrangement 10 are at least partially transparent to the idler light, as indicated in FIG. 1A. Idler light 20, 20′ thus leaves the mirror arrangement 10 and is no longer available in a subsequent cycle, for example for reconversion, i.e. the recombination of signal light 14 and idler light into pump light 12. After several cycles, the signal light 14 leaves the mirror arrangement 10. Here, the first mirror 18A also serves as an out-coupling mirror for the signal light 14. The remaining pump light 12 is also guided out of the amplifier arrangement 10. In the example shown in FIG. 1A, the pump light 12 passes through five cycles when passing through the mirror arrangement 10. During each of these cycles, the crystal is passed through twice, so that pump light 12 is passed through the amplifier crystal a total of 10 times by the mirror arrangement.

In particular, each of the mirror arrangements 10 of the figures can be passed through bidirectionally, so that the mirror arrangement 10 can be operated in a resonator. Here, pump light is then coupled in via the first mirror 18A, wherein generated signal light leaves the mirror arrangement 10 via the second mirror 18B. The arrows in the figures for pump light 12 and signal light 14 must be interchanged.

By using the multi-pass geometry of the mirror arrangement 10, good power scaling can be achieved and, in particular, it is possible to use only a short amplifier crystal. By using a short amplifier crystal, reconversion can be suppressed and a high gain bandwidth can be guaranteed at the same time. Thus, an optical parametric amplifier with a high gain, a wide gain bandwidth and a high conversion efficiency is provided. In particular, the photon conversion efficiency is more than 60%, particular more than 70% and preferably more than 80%. Here, the large gain bandwidth can be used to directly amplify pulses with a pulse length of less than 1 ps, in particular less than 500 fs and preferably up to a pulse length of 10 fs.

As shown in FIG. 1A, the optical parametric amplifier requires only a small number of optical elements, so that costs and adjustment effort can be kept to a minimum. At the same time, costs can be reduced as small crystals can be used. In particular, the time-consuming step of periodic poling is not necessary, so that an inexpensive amplifier crystal can be used.

FIGS. 1B to 1D show alternative embodiments. Here, in particular the arrangement of the amplifier crystal 17 is changed. In FIG. 1B, the amplifier crystal is arranged in the beam path between the first mirror 18A and the second mirror 18B. Pump light 12 passes through the amplifier crystal 17 at different locations together with the signal light 14. This allows a large interaction distance to be achieved between the amplifier crystal 17 and the pump light 12 to amplify the signal light. This can be particularly advantageous when using long amplifier crystals having lengths of more than 25 mm and especially when amplifying long pulse lengths of more than 1 ps, 1 ns or cw operation.

FIG. 1C shows an alternative embodiment, wherein the first mirror 18A, the second mirror 18B and the amplifier crystal 17 are monolithically formed. In particular, the mirrors 18A and 18B are integrated into side surfaces of the amplifier crystal 17, for example by a suitable coating of the side surfaces to form a dichroic mirror. In particular, the crystal mirror 16 can also be formed monolithically with the amplifier crystal 17.

In the embodiment of FIG. 1D, the focusing mirror 19 is also formed monolithically with the amplifier crystal 17, so that the entire mirror arrangement 10 is formed together with the amplifier crystal 17.

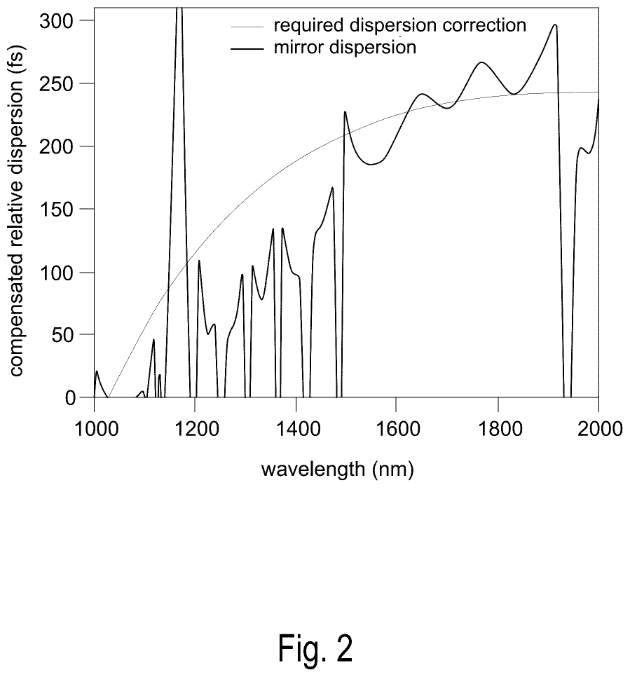

FIG. 2 shows the group velocity dispersion of the mirrors 18A, 18B, 19. Here, group velocity compensation is achieved in a range of approximately 1450 nm-1900 nm, which just compensates for the dispersion of the pump light and the signal light. It can be seen that in a range of approximately 1450 nm-1900 nm sufficient compensation of the dispersion is enabled by the mirrors.

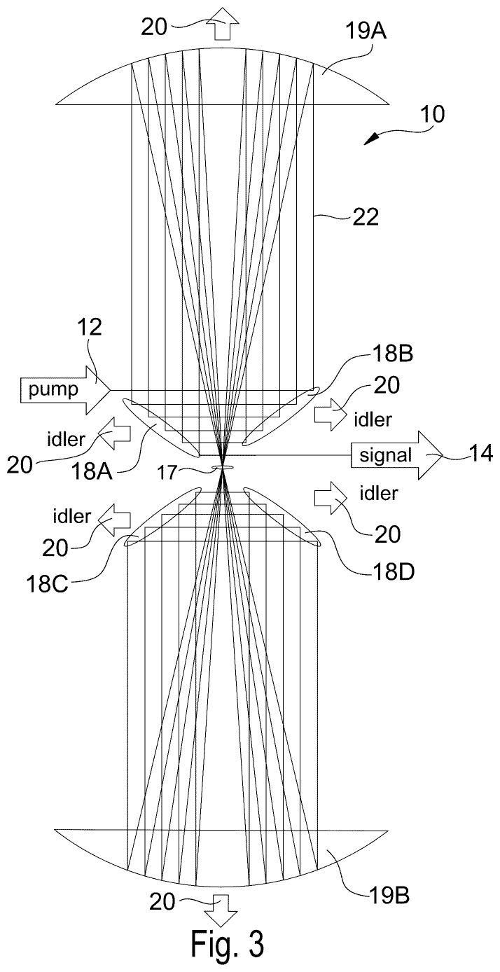

Reference is made to FIG. 3. The embodiment of the optical parametric amplifier of FIG. 3 shows a mirror arrangement 10′ in which, compared to the mirror arrangement 10 of FIGS. 1A to 1D, the crystal mirror 16 has been removed and a symmetrical mirror arrangement has been arranged below the amplifier crystal 17. Identical or similar components are marked with identical reference numerals in FIG. 3.

Thus, the mirror arrangement 10′ of FIG. 3 comprises a first mirror 18A, a second mirror 18B, a third mirror 18C and a fourth mirror 18D. Furthermore, the mirror arrangement 10 has a first focusing mirror 19A and a second focusing mirror 19B. Focusing mirror 19A and focusing mirror 19B are arranged in such a way that they have a common focal point. The amplifier crystal 17 is arranged at this common focal point.

Pump light 12 and signal light 14 are thus reflected in a cycle starting at the first mirror 18A to the second mirror 18B. Pump light 12 and signal light 14 are reflected from the second mirror 18B to the first focusing mirror 19A and then focused onto the amplifier crystal 17. The pump light 12 passes through the amplifier crystal 17 and signal light 14 and idler light are generated. Signal light, idler light and pump light reach the second focusing mirror 19B. At least pump light 12 and signal light 14 are reflected here to the third mirror 18C and therefrom reflected to the fourth mirror 18D. From the fourth mirror 18D, pump light 12 and signal light 14 return to the second focusing mirror 19B, are focused again on the amplifier crystal 17 and return to the first focusing mirror 19A, from which they are reflected onto the first mirror 18A. In this respect, pump light 12 and signal light 14 pass through several cycles. Idler light 20 is not reflected or at least partially not reflected on one of the mirrors 18A, 18B, 18C, 18D, for example. Similarly, the first focusing mirror 19A or the second focusing mirror 19B cannot or can only partially reflect idler light 20. Idler light 20 is thus transmitted to the mirror or absorbed and is no longer available for a reconversion process in the amplifier crystal 17. After passing through several cycles, the signal light 14 is then coupled out via an out-coupling mirror, which is provided by the first mirror 18A. Similarly, any remaining pump light 12 is also coupled out. The embodiment of FIG. 3 is particularly suitable for high power levels, as no mirror has to be provided in the area of the focus, i.e. in the area of high power density.

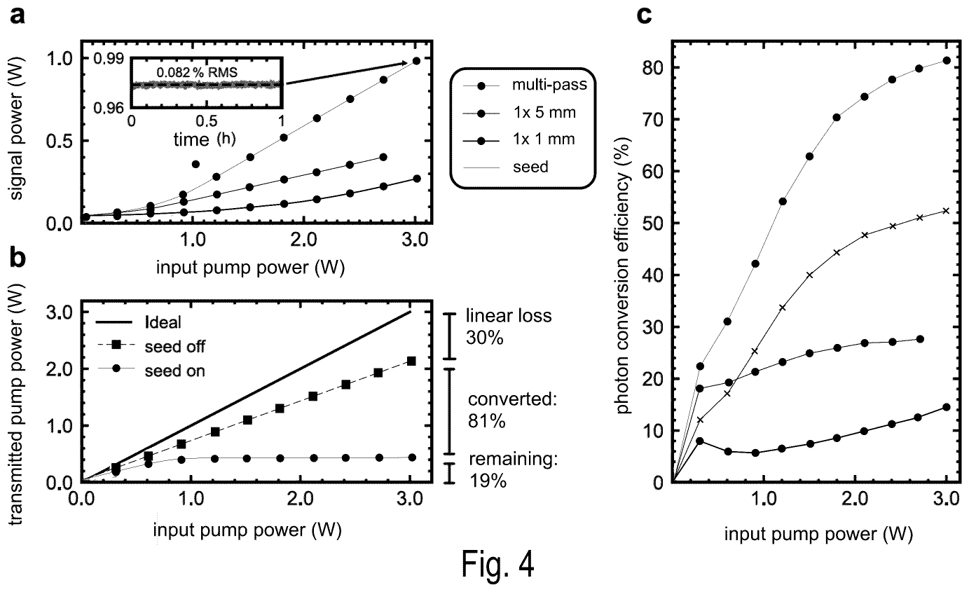

FIG. 4 shows a characterization of the optical parametric amplifier according to FIG. 1. Here, FIG. 4a shows the resulting signal power for different pump powers (“multi-pass”). As a comparison, the simple passage through a 1 mm long crystal and a 5 mm long crystal is shown. As can be clearly seen from FIG. 4a, the optical parametric amplifier according to the present invention has good scalability.

FIG. 4b shows the conversion efficiency. This shows that 81% of the pump light is converted into signal light and/or idler light. This is also shown in FIG. 4c for different pump powers, wherein it can be seen that the conversion efficiency is significantly higher than the single passages through a 5 mm long crystal or a 1 mm long crystal shown as a comparison.

Thus, an optical parametric amplifier having a very high conversion efficiency and good scalability of performance is provided.

1. An optical parametric amplifier, comprising
an amplifier crystal, and
a mirror arrangement having a plurality of mirrors,
wherein the mirror arrangement has an in-coupling mirror and an out-coupling mirror, wherein pump light is coupled into the mirror arrangement via the in-coupling mirror, wherein signal light and idler light are generated in the amplifier crystal by means of the pump light, wherein the signal light leaves the mirror arrangement via the out-coupling mirror,
wherein in the mirror arrangement the pump light is directed several times through the amplifier crystal in several cycles in the mirror arrangement, and
wherein the pump light and signal light are guided collinearly in the mirror arrangement.

2. The optical parametric amplifier according to claim 1, wherein the pump light passes through the mirror arrangement only once.

3. The optical parametric amplifier according to claim 1, wherein the mirror arrangement is arranged in a resonator, in particular a fiber feedback resonator.

4. The optical parametric amplifier according to claim 1, wherein the amplifier crystal is arranged in a focal point of the mirror arrangement.

5. The optical parametric amplifier according to claim 1, wherein the pump light and/or the signal light hits several times on one or more mirrors of the mirror arrangement.

6. The optical parametric amplifier according to claim 1, wherein one or more of the mirrors of the mirror arrangement are at least partially transparent to the idler light.

7. The optical parametric amplifier according to claim 1, wherein the amplifier crystal has a length which is equal to or less than the walk-off length between the signal light and the pump light.

8. The optical parametric amplifier according to claim 1, wherein the pump light is reflected on one or more of the mirrors at different locations on a mirror surface of the mirror.

9. The optical parametric amplifier according to claim 1, wherein the dispersion of the mirrors of the mirror arrangement compensate for the dispersion of signal light and pump light per cycle.

10. The optical parametric amplifier according to claim 1, wherein the photon conversion efficiency is greater than 60%, preferably greater than 70% and particularly preferably greater than 80%.

11. The optical parametric amplifier according to claim 1, wherein the mirror arrangement comprises a first mirror, a focusing mirror, a second mirror and a crystal mirror, wherein a cycle comprises: a first reflection on the first mirror to the focusing mirror, a second reflection on the focusing mirror to the crystal mirror, a third reflection on the crystal mirror to the focusing mirror, a fourth reflection on the focusing mirror to the second mirror and a fifth reflection on the second mirror to the first mirror, wherein pump light and signal light pass through several cycles.

12. The optical parametric amplifier according to claim 11, wherein the amplifier crystal is passed through between the focusing mirror and the crystal mirror.

13. The optical parametric amplifier according to claim 11, wherein the amplifier crystal is passed through between the second mirror and the first mirror, the amplifier crystal being passed through in particular at different locations.

14. The optical parametric amplifier according to claim 1, wherein the mirror arrangement comprises a first mirror, a first focusing mirror, a second mirror, a third mirror, a second focusing mirror and a fourth mirror, the first focusing mirror and the second focusing mirror having a common focal point at which the amplifier crystal is arranged.

15. The optical parametric amplifier according to claim 13, wherein a cycle comprises: a first reflection on the first mirror to the first focusing mirror, a second reflection on the first focusing mirror to the second focusing mirror, a third reflection on the second focusing mirror to the second mirror, a fourth reflection on the second mirror to the third mirror, a fifth reflection on the third mirror to the second focusing mirror, a sixth reflection on the second focusing mirror to the first focusing mirror, a seventh reflection on the first focusing mirror to the fourth mirror and an eighth reflection on the fourth mirror to the first mirror, wherein the pump light and signal light pass through several cycles.
